(19) United States
(12) Patent Application Publication
(10) Pub. No.: US 2020/0099987 A1
(43) Pub. Date: Mar. 26, 2020

(54) SYSTEMS AND METHODS FOR DISPLAYING A LIVE VIDEO STREAM IN A GRAPHICAL USER INTERFACE

(71) Applicant: FuboTV Inc., New York, NY (US)

(72) Inventors: Christopher Michael Petrillo, Brooklyn, NY (US); Frederic Kullmann, Brooklyn, NY (US)

(73) Assignee: FuboTV Inc., New York, NY (US)

(21) Appl. No.: 16/580,920

(22) Filed: Sep. 24, 2019

Related U.S. Application Data
(60) Provisional application No. 62/735,676, filed on Sep. 24, 2018.

(51) Int. Cl. H04N 21/482; G06F 3/0485; H04N 21/2187; H04N 21/472

(52) U.S. Cl. CPC H04N 21/482; H04N 21/47202; H04N 21/2187; G06F 3/0485

(57) ABSTRACT

The disclosed technology relates to playing a live video stream in a graphical user interface upon preselection of a live video stream from a plurality of live video streams. The graphical user interface is configured to play a live video stream of a plurality of live video streams in a background portion of the graphical user interface upon preselection of the live video stream from a scrolling portion of the graphical user interface. The scrolling portion is removed from the graphical user interface in response to a selection of the live video stream.

### PRIORITY

This application claims the benefit under 35 U.S.C. § 119(e) of U.S. Provisional Patent Application Ser. No. 62/735,676, entitled “SYSTEMS AND METHODS FOR DISPLAYING A LIVE VIDEO STREAM IN A GRAPHICAL USER INTERFACE,” filed on Sep. 24, 2018, which is incorporated herein by reference in its entirety.

### TECHNICAL FIELD

This present disclosure relates generally to systems and methods for playing a live video stream in a graphical user interface, and more particularly to dynamically playing a live video stream upon preselection of the video stream from a plurality of live video streams.

### BACKGROUND

Conventionally, to play or display a video stream, a user must first select the video stream from a channel guide. In other words, the video is not displayed or played until after the user selects the desired video stream from the channel guide. A user that does not know what the content of a video stream includes, must therefore first select the video stream to observe the video stream's content. In addition, where a user wishes to view a particular video stream after the content of the video stream has commenced broadcasting (e.g., a user decides to watch a broadcast of a sporting event after the sporting event has started), the user must select the video stream to observe how much of the content has already been displayed, played, or broadcast. Requiring a user to first select a video stream from a channel guide for viewing can be cumbersome, difficult, and lead to frustration.

### SUMMARY

One aspect of the present disclosure relates to a method for playing a live video stream from a plurality of live video streams. The method includes generating a graphical user interface comprising a scrolling portion and a background portion. The scrolling portion displays a plurality of live video streams for preselection and selection. The method further includes playing a first live video stream of the plurality of live video streams in the background portion in response to a preselection of the first live video stream from the scrolling portion. The method also includes removing the scrolling portion from the graphical user interface in response to a selection of the first live video stream.

Another aspect of the present disclosure relates to a non-transient computer-readable storage medium having instructions embodied thereon, the instructions being executable by a computing system to generate a graphical user interface comprising a scrolling portion and a background portion. The scrolling portion displays a plurality of live video streams for preselection and selection. The instructions further cause the computing system to play a first live video stream of the plurality of live video streams in the background portion in response to a preselection of the first live video stream from the scrolling portion. The instructions further cause the computing system to remove the scrolling portion from the graphical user interface in response to a selection of the first live video stream.

Yet another aspect of the present disclosure relates to a system configured for playing a live video stream from a plurality of live video streams. The system may include a processor and a non-transitory computer-readable medium comprising instructions stored therein, that when executed by the processor, cause the processor to generate a graphical user interface comprising a scrolling portion and a background portion. The scrolling portion displays a plurality of live video streams for preselection and selection. The instructions further cause the processor to play a first live video stream of the plurality of live video streams in the background portion in response to a preselection of the first live video stream from the scrolling portion. The instructions further cause the processor to remove the scrolling portion from the graphical user interface in response to a selection of the first live video stream

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a conceptual block diagram illustrating an example system for dynamically playing a live video stream upon preselection of the video stream from a graphical user interface, in accordance with various aspects of the subject technology;

FIG. 2A depicts a graphical user interface, in accordance with various aspects of the subject technology;

FIG. 2B depicts a graphical user interface, in accordance with various aspects of the subject technology;

FIG. 2C depicts a graphical user interface, in accordance with various aspects of the subject technology;

FIG. 3 depicts an example method for playing a live video stream from a plurality of live video streams, in accordance with various aspects of the subject technology; and

FIG. 4 illustrates an example of a system configured for dynamically playing a live video stream upon preselection of the video stream from a graphical user interface, in accordance with some aspects.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Conventionally, to play or display a live video stream, a user must first select the live video stream from a channel guide. In other words, the live video is not displayed or played until after the user selects the desired live video stream. A user that does not know what the content of a live video stream includes, must therefore first select the live video stream to observe the video stream's content. In addition, where a user wishes to view a particular live video stream after the content has commenced broadcasting (e.g., a user decides to watch a broadcast of a sporting event after the sporting event has started), the user must select the live video stream to observe how much of the content has already been displayed, played, or broadcast. Requiring a user to first select a live video stream from a channel guide for viewing can be cumbersome, difficult, and lead to frustration. Accordingly, there is a need for certain embodiments of a graphical user interface that dynamically plays content of a live video stream upon preselection of the live video stream from a plurality of live video streams.

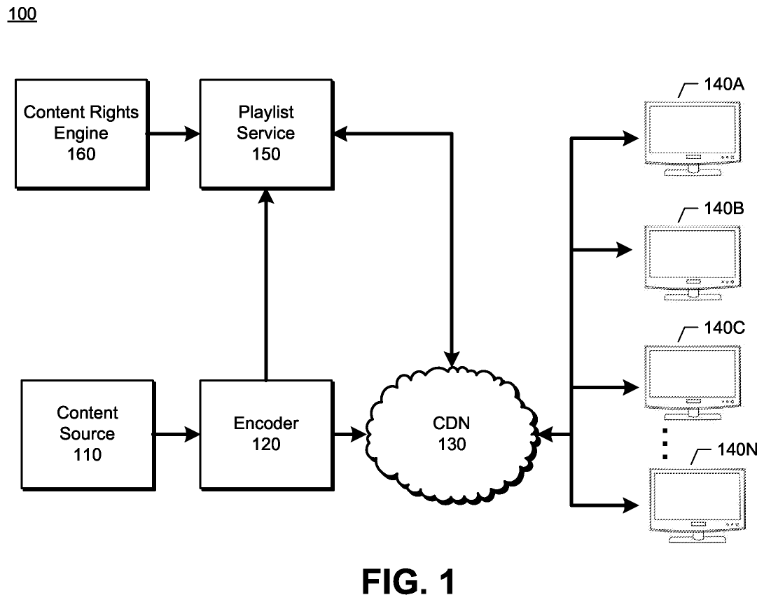

The disclosed technology addresses the foregoing limitations of conventional graphical user interfaces or channel guides by providing to a user a plurality of live video streams to select in a scrolling portion. Upon preselection of a first live video stream of the plurality of live video streams, the graphical user interface is configured to present or play the live content of the first live video stream to the user in a background portion to enable the user to easily observe the content of the preselected video stream. The user may then select the first live video stream to play or may preselect or navigate to a second live video stream of the plurality of live video streams. If the user preselects the second live video stream of the plurality of live video streams, the graphical user interface is configured to terminate the presentation or playing of the first live video stream and initiate presentation or playing of the second live video stream. If the user selects the second live video stream to play, the graphical user interface is configured to remove the plurality of live video streams from the display, and allow the user to view the content of the second live video stream without any menu items or navigation menus displayed. Additional aspects of the graphical user interface are discussed with respect to FIGS. 1-3, below.

FIG. 1 is a conceptual block diagram illustrating an example system 100 for dynamically playing a live video stream upon preselection of the video stream from a graphical user interface, in accordance with various aspects of the subject technology. Various aspects are discussed with respect to a general wide area network for illustrative purposes, however, these aspects and others may be applied to other types of networks. For example, a network environment may be implemented by any type of network and may include, for example, any one or more of an enterprise private network (EPN), cellular network, a satellite network, a personal area network (PAN), a local area network (LAN), a broadband network (BBN), or a network of public and/or private networks, such as the Internet, or the like. The system 100 may be implemented using any number of communications links associated with one or more service providers, including one or more wired communication links, one or more wireless communication links, or any combination thereof. Additionally, the system 100 can be configured to support the transmission of data formatted using any number of protocols.

The system 100 includes a content source 110, an encoder 120, a content distribution network 130, one or more client devices 140A-N, a playlist service 150, and a content rights engine 160. In one aspect, the system 100 may include additional components, fewer components, or alternative components, such as additional encoders, different networks for different clients, and/or additional third-party servers. The system 100 may be implemented as a single machine or distributed across a number of machines in a network, and may comprise one or more servers.

The devices (e.g., encoder 120, client devices 140A-N, playlist service 150, and content rights engine 160) may be connected over links through ports. Any number of ports and links may be used. The ports and links may use the same or different media for communications. Wireless, microwave, wired, Ethernet, digital sub scriber lines (DSL), telephone lines, T1 lines, T3 lines, satellite, fiber optics, cable and/or other links may be used.

According to the subject technology disclosed herein, a remote content source 110 or provider and may provide a compressed video signal representing live video to one or more encoders 120. The content provided by the content source 110 may be transmitted or broadcasted by a data link, such as for example, a satellite, a terrestrial fiber cable, and/or an antenna. The compressed video signal received by the one or more encoders 120 may, for example, be compressed using a video encoder that may be a device or program that compresses data to enable faster transmission. The video encoder may compress the data into one or more video compression standards, such as H.265 and H.264 per one or more coding standards, such as MPEG-H, MPEG-4, and MPEG-2. The compressed video signal may contain video data representing programming and advertisements (e.g., content). The compressed video signal, may further include markers that delimit the advertisements to enable replacement or insertion of a particular advertisement within the programming (e.g., local advertisement insertion opportunity), scheduling information, and/or data representing one or more characteristics of the content associated with the programming. In one aspect, the markers, scheduling information, and/or content characteristics, may comply with certain standards, such as the SCTE-35 standard.

The compressed video signal may be processed to extract data, such as metadata representing the markers, scheduling (e.g., time slot), content characteristics (e.g., content title, content description, image representing the content such as a logo, still frame, or thumbnail), network information (e.g., network name), and/or the SCTE-35 information. In one aspect, the metadata extracted from the compressed video signal may be used to generate a graphical user interface, as discussed further below.

In some aspects, the encoder 120 may be configured to receive the compressed video signal and output encoded video data (e.g., video stream encoded in various resolutions and bitrates) to the content distribution network 130. The encoded video data output by the encoder 120 may comprise encoded segments of content associated with a video stream, provided in several versions—where each version provides the content at a different resolution and bitrate (e.g., profiles). In one aspect, the encoder 120 may be configured to decode, encode, and/or transcode the compressed video stream using one or more video compression standards, such as H.265 and H.264 per one or more coding standards, such as MPEG-H, MPEG-4, and MPEG-2.

The encoder 120 may also be configured to fragment, segment, or divide each respective profile into individual files (e.g., segments). Each segment may be configured to be individually decodable without requiring data from a previous or subsequent segment to start decoding a particular segment. For example, for encoded video data comprising an H.264 video stream generated by the encoder 120, the segments for each profile of the plurality of profiles may comprise a few seconds of the content. In this example, such segments may each have a duration of about 2-30 seconds, and may typically have a duration of about 4-10 seconds. In other aspects, fragmentation, segmentation, and/or division of each respective profile into individual files (e.g., segments) may be performed by a packager that is configured to receive encoded video data from the encoder 120 and output the segments. In one aspect, the segments may be provided to the content distribution network (“CDN”) 130 for storage, caching and/or serving to client devices 140A-N.

The encoder 120 may also be configured to generate a manifest that associates a plurality of queue points to the individual segments of the content. The queue points may be organized or listed in a particular order or sequence, to ensure proper playback or reading of the segmented and encoded video segments by the client device 140A-N. The encoder 120 may further be configured to generate a high-level or master manifest that identifies the profiles and their characteristics (e.g., resolution, bitrate) for the content. The manifests may comprise text files that are provided to the playlist service 150.

The CDN 130 may comprise a geographically distributed network of servers and/or data centers. CDN 130 distributes service spatially relative to the client devices 140A-N to provide high availability and high performance. The CDN 130 may store the video segments provided by the encoder 120 or packager and serve the video segments to the client devices 140A-N. CDN 130 may include various physical network devices (e.g., servers, routers, or switches, etc.) or virtual network devices (e.g., that are instantiated as containers or virtual machines) for serving the video segments to the client devices 140A-N. The CDN 130 may be configured to receive requests for content from client devices 140A-N, and serve video segments to the client devices 140A-N.

The playlist service 150 may be configured to generate a playlist for each client device 140A-N in response to receiving a request for content from a client device 140A-N. The playlist may comprise a set of queue points or reference a set of queue points, that point to video segments stored at the CDN 130. In some aspects, the playlist service 150 identifies, arranges, and compiles a set of queue points derived from manifests to generate a playlist of video segments to facilitate playback or display of the content at respective client devices 140A-N. The playlist generated by the playlist service 150 is configured to reference video segments stored at the CDN 130, that when played or displayed according to the playlist, enables playback of the video segments served by the CDN 130 by a particular client device 140A-N at the appropriate resolution for a particular client device 140A-N. In some aspects, the playlist generated by the playlist service 150 facilitates playback of the video segments referenced in the playlist at different bitrates and/or resolutions.

In some aspects, the playlist service 150 is configured to enforce blackout rules or geographical limitations (e.g., blackout data) imposed by the remote content source 110 or content provider by generating a playlist for a particular client device 140A-N that includes queue points to segments of content that the particular client device 140A-N has access to view or play. The blackout data associated with the content may be provided to the playlist service 150 by the content rights engine 160. The blackout data may include content viewing restrictions based on at least one of a current location of the client device 140A-N, a billing location of the client device 140A-N, and/or a characteristic of the client device 140A-N (e.g., client type, operating system, network connection, available bandwidth, network protocol, screen size, device type, display capabilities, and/or codec capabilities). For example, the blackout data may identify specific content that may be restricted to viewers based on zip code, city, market or state, may include a schedule for a blackout, and/or may identify alternate content to display in lieu of the restricted content. Using the blackout data, the playlist service 150 may determine the content rights applicable to content requested by a particular client device 140A-N and based on the determined content rights, generate a playlist that references queue points for allowed content.

The client devices 140A-N may include machines (e.g., televisions, monitors, servers, personal computers, laptops), virtual machines, containers, mobile devices (e.g., tablets or smart phones), or smart devices (e.g., set top boxes, smart appliances, smart televisions, internet-of-things devices). The clients 140A-N may utilize software applications, browsers, or computer programs that are running on a device such as a desktop computer, laptop computer, tablet computer, server computer, smart television, smartphone, or any other apparatus on which an application (e.g., client application) is running that at some point in time, involves a client requesting content and/or receiving streaming live video provided by the system 100. The client devices 140A-N may utilize a touch sensitive user interface, such as a touch-sensitive screen or remote control, to receive user input. The touch screen of the device may be built into the device itself, or can be electronically connected to the device (e.g., as a peripheral device). The user input may comprise gestures or touch.

One or more of the applications running on the client devices 140A-N may include application data comprising a graphical user interface. The application may be configured to solicit user input using the graphical user interface and to receive the user input using the touch-sensitive screen or remote control. The graphical user interface is configured to trigger an application function based on user input, such as preselection of a live video stream or selection of a live video stream.

Each client device 140A-N is thus configured to generate and display the graphical user interface to enable a user associated with each respective client device 140A-N, to scroll through a plurality of live video streams, navigate to a particular live video stream among a plurality of live video streams, play a preselected live video stream, and select a live video stream. Upon preselection of a first live video stream of the plurality of live video streams (e.g., navigating to a live video stream among a listing of live video streams), the graphical user interface is configured to present or play the content of the first live video stream in a background portion to enable the user to observe the content of the first live video stream without requiring selection of the first live video stream. In other words, the user may view and observe the content of the first live video stream in a background portion of the graphical user interface without requiring actual selection of the first live video stream from the plurality of live video streams. By allowing the user to observe the content of the first live video stream in the background portion of the graphical user interface, the user may continue to navigate to other available live video streams that are displayed in a scrolling portion of the graphical user interface without requiring the user to navigate across multiple menus or screens. For example, upon preselection of a second live video stream of the plurality of live video streams, the graphical user interface is configured to replace the first live video stream playing in the background portion with the second live video stream.

In one aspect, displaying or playing the content of a preselected live video stream in the background portion of the graphical user interface enables the user to view the content (e.g., live broadcast of a sporting event, live transmission of a news event, real-time broadcast of content provided by a network or channel) of the preselected live video stream without requiring selection of the live video stream, thereby enabling the user to easily navigate among the plurality of live video streams without any delay associated with requiring the user to repeatedly select a desired live video stream to view the corresponding content, and return back to a menu of a plurality of live video streams to select a different live video stream for viewing. In other words, the graphical user interface enables the user to navigate among the plurality of live video streams while also viewing the live or real-time content associated with each live video stream of the plurality of live video streams seamlessly, without requiring individual selection of a live video stream to view its associated content.

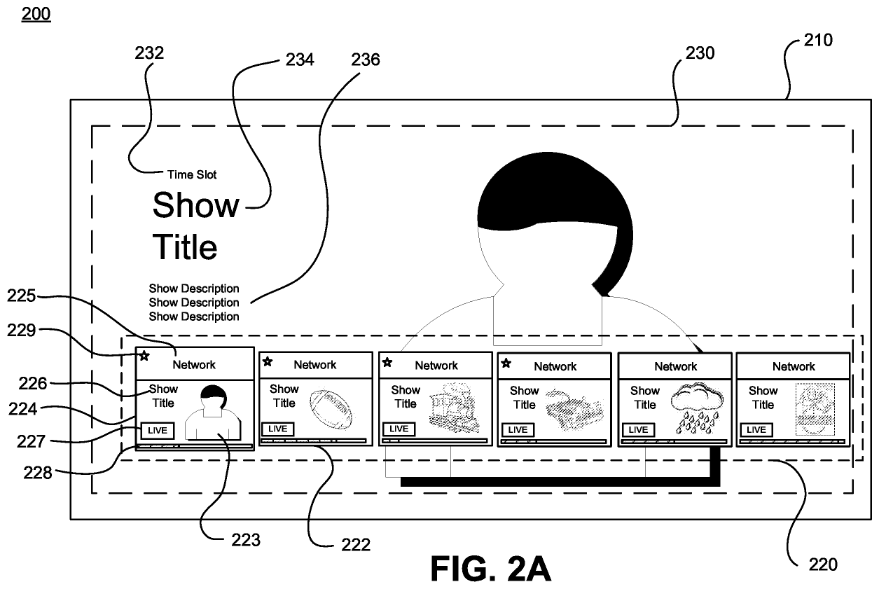

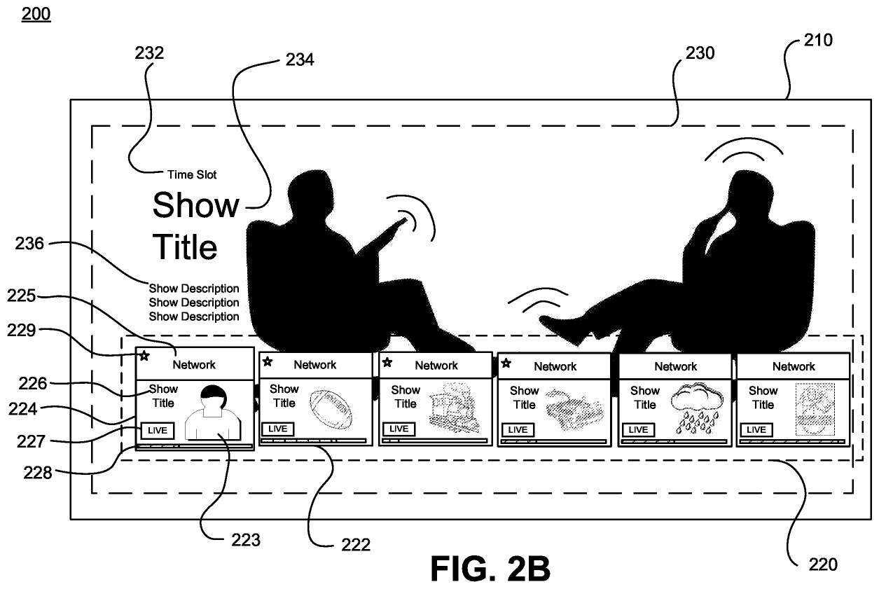

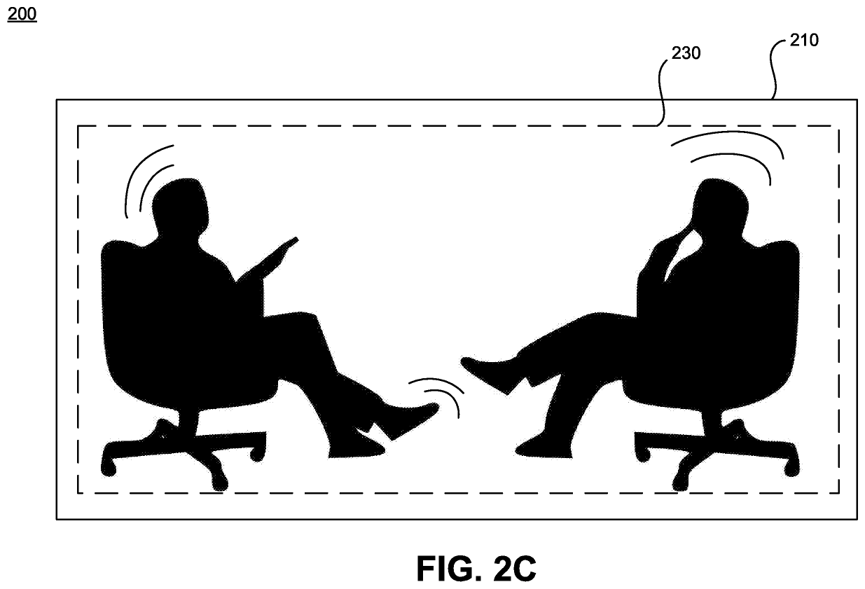

FIG. 2A depicts a graphical user interface 200, in accordance with various aspects of the subject technology. The graphical user interface 200 comprises a display area 210 having a scrolling portion 220 and a background portion 230. The scrolling portion 220 comprises a plurality of live video streams 222 for preselection and selection. The scrolling portion 220 may be presented on a lower half of the display area 210 and may be configured to scroll left or right based on user input. As a user scrolls through the plurality of live video streams 222 displayed in the scrolling portion 220, the live video streams 222 are scrolled past a focus disposed at an end of the scrolling portion 220. The live video stream presented in the focus is designated as a preselected live video stream 224 and is enlarged with respect to the other live video streams 222 displayed in the scrolling portion 220 to inform the user that the preselected video stream 224 is currently preselected.

The scrolling portion 220 also displays metadata for each live video stream 222. The displayed metadata may include an image 223 comprising a visual representation of the content (e.g., still frame, logo, thumbnail), a network name 225, content title 226, a “LIVE” designation 227 indicating that the content is a live broadcast, elapsed information 228 representing how much of the content has elapsed, and/or a favorite designation 229 indicating whether the live video stream 222 has been previously identified as a “Favorite” channel or network. In one aspect, the plurality of live video streams 222 are arranged within the scrolling portion 220 in order of a user's preference. For example, the live video streams may be arranged to display “favorited” channels or networks first, followed by non-favorited channels or networks.

FIG. 2B depicts the graphical user interface 200, in accordance with various aspects of the subject technology. Upon preselection of a live video stream 224, the background portion 230 plays the preselected live video stream 224. In one aspect, prior to playing, the image 223 or other metadata associated with the preselected live video stream 224 may be displayed in the background portion 230 during loading or tuning of the preselected live video stream 224 (as shown in FIG. 2A). In one aspect, displayed alongside the preselected live video stream 224 in the background portion 230, metadata associated with the preselected live video stream 224 may be displayed to the user. The metadata displayed in the background portion 230 may include a time slot 232, content title 234, and/or content description 236.

During playing of the preselected live video stream 224, the graphical user interface 200 is configured to display the scrolling portion 220 to enable the user to preselect a different live video to play. The user may thus scroll, one by one, through the plurality of live video streams 222 displayed in the scrolling portion 220 until a desired live video stream is preselected by navigating the desired live video stream to the focus. As the user preselects a particular live video stream, the background portion 230 dynamically plays the content broadcast in the preselected live video stream 224 without requiring the user to navigate through different menus or screens. In one aspect, by enabling a user to navigate through the plurality of live video streams 222 while also playing the preselected live video stream 224 on a single display, a user is able to easily navigate across different channels or networks, determine what content is playing on a particular channel or network, as well as ascertain where in time a particular broadcast is with respect to the user.

In one aspect, the preselected live video stream 224 played in the background portion 230 is initially displayed with reduced brightness to demonstrate to the user that the preselected live video stream 224 has not yet been selected for normal display (e.g., at regular brightness and without display of the scrolling portion 220). The graphical user interface 200 thus enables the user to view the content of the preselected live video stream 224 without requiring the user to individually select the live video stream to view its associated content.

FIG. 2C depicts the graphical user interface 200, in accordance with various aspects of the subject technology. The graphical user interface 200 is also configured to remove the scrolling portion 220 from the display area 210 in response to a selection of the preselected live video stream 224. To select the preselected live video stream 224 for normal display in the display area 210, the user may simply maintain the focus on the preselected live video stream 224 for a predetermined amount of time (e.g., 5 seconds, 10 seconds, 15 seconds, 20 seconds, etc.). Alternatively, the user may select the preselected live video stream 224 for normal display in the display area 210 by providing input, such as by depressing a button on a remote control. For example, the user may select the preselected live video stream 224 by depressing a “play” button to indicate that the preselected live video stream 224 has been selected for viewing. Upon selection of the preselected live video stream 224, the graphical user interface 200 removes the scrolling portion 220 and the content is displayed at full brightness without any navigation or menu options displayed.

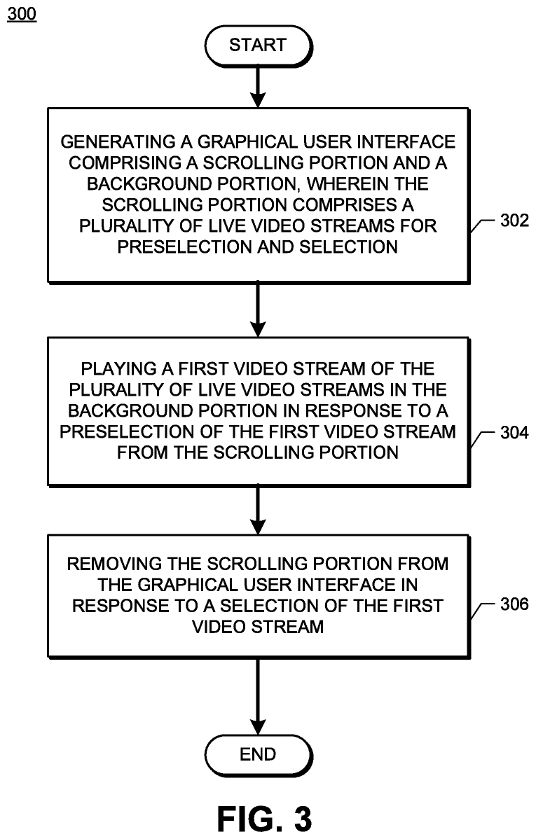

FIG. 3 depicts an example method 300 for playing a live video stream from a plurality of live video streams, in accordance with various aspects of the subject technology. It should be understood that, for any process discussed herein, there can be additional, fewer, or alternative steps performed in similar or alternative orders, or in parallel, within the scope of the various aspects unless otherwise stated. The method 300 can be performed by a system for playing a live video stream from a plurality of live video streams (e.g., the system 100 of FIG. 1) or similar system.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include generating a graphical user interface comprising a scrolling portion and a background portion. The scrolling portion comprises a plurality of live video streams for preselection and selection. The scrolling portion may further comprise metadata for each live video stream of the plurality of live video streams. The metadata may include a network name, content title, an image, and elapsed information. An operation 304 may include playing a first live video stream of the plurality of live video streams in the background portion in response to a preselection of the first live video stream from the scrolling portion. Preselection of the first live video stream may comprise navigating the first live video stream to a focus of the scrolling portion. The background portion may also display metadata for the first live video stream that may include a time slot, content title, and content description. An operation 306 may include removing the scrolling portion from the graphical user interface in response to a selection of the first live video stream. Selection of the first live video stream may comprise maintaining the focus on the first live video stream for a predetermined amount of time, or receiving an input from a user to select the first live video stream.

The method 300 may further include arranging the plurality of live video streams in the scrolling portion based on preference of a user; and displaying an image associated with the first live video stream in the background portion.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

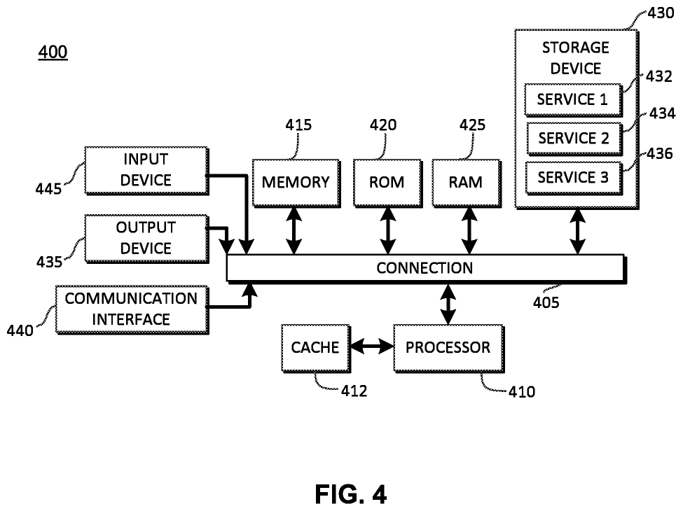

FIG. 4 depicts an example of a computing system 400 in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments computing system 400 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

System 400 includes at least one processing unit (CPU or processor) 410 and connection 405 that couples various system components including system memory 415, such as read only memory (ROM) 420 and random access memory (RAM) 425 to processor 410. Computing system 400 can include a cache 412 of high-speed memory connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

It will be appreciated that computing system 400 can have more than one processor 410, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

As used herein, the term “module” may refer to any component or set of components that perform the functionality attributed to the module. This may include one or more physical processors during execution of processor readable instructions, the processor readable instructions, circuitry, hardware, storage media, or any other components.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method for playing a live video stream from a plurality of live video streams, comprising:
generating a graphical user interface comprising a scrolling portion and a background portion, wherein the scrolling portion comprises a plurality of live video streams for preselection and selection;
playing a first live video stream of the plurality of live video streams in the background portion in response to a preselection of the first live video stream from the scrolling portion; and
removing the scrolling portion from the graphical user interface in response to a selection of the first live video stream.

2. The computer-implemented method of claim 1, further comprising arranging the plurality of live video streams in the scrolling portion based on preference of a user.

3. The computer-implemented method of claim 1, further comprising displaying an image associated with the first live video stream in the background portion.

4. The computer-implemented method of claim 1, wherein the preselection of the first live video stream comprises navigating the first live video stream to a focus of the scrolling portion.

5. The computer-implemented method of claim 4, wherein the selection of the first live video stream comprises maintaining the focus on the first live video stream for a predetermined amount of time.

6. The computer-implemented method of claim 1, wherein the selection of the first live video stream comprises receiving an input from a user to select the first live video stream.

7. The computer-implemented method of claim 1, wherein the scrolling portion further comprises metadata for each live video stream of the plurality of live video streams, the metadata comprising network name, content title, and an image.

8. The computer-implemented method of claim 7, wherein the scrolling portion further comprises elapsed information for each live video stream of the plurality of live video streams.

9. The computer-implemented method of claim 1, wherein the background portion further comprises metadata for the first live video stream, the metadata comprising a time slot, content title, and content description.

10. A non-transitory computer-readable medium comprising instructions stored therein, the instructions, when executed by a computing system, cause the computing system to:
generate a graphical user interface comprising a scrolling portion and a background portion, wherein the scrolling portion comprises a plurality of live video streams for preselection and selection;
play a first live video stream of the plurality of live video streams in the background portion in response to a preselection of the first live video stream from the scrolling portion; and
remove the scrolling portion from the graphical user interface in response to a selection of the first live video stream.

11. The non-transitory computer-readable medium of claim 10, wherein the instructions further cause the computing system to arrange the plurality of live video streams in the scrolling portion based on a preference of a user.

12. The non-transitory computer-readable medium of claim 10, wherein the preselection of the first live video stream comprises navigating the first live video stream to a focus of the scrolling portion.

13. The non-transitory computer-readable medium of claim 12, wherein the selection of the first live video stream comprises maintaining the focus on the first live video stream for a predetermined amount of time.

14. The non-transitory computer-readable medium of claim 10, wherein the selection of the first live video stream comprises receiving an input from a user to select the first live video stream.

15. The non-transitory computer-readable medium of claim 10, wherein the scrolling portion further comprises metadata for each live video stream of the plurality of live video streams, the metadata comprising network name, content title, and an image.

16. The non-transitory computer-readable medium of claim 10, wherein the background portion further comprises metadata for the first live video stream, the metadata comprising a time slot, content title, and content description.

17. A system comprising:
a processor; and
a non-transitory computer-readable medium comprising instructions stored therein that, when executed by the processor, cause the processor to:
generate a graphical user interface comprising a scrolling portion and a background portion, wherein the scrolling portion comprises a plurality of live video streams for preselection and selection;
play a first live video stream of the plurality of live video streams in the background portion in response to a preselection of the first live video stream from the scrolling portion; and
remove the scrolling portion from the graphical user interface in response to a selection of the first live video stream.

18. The system of claim 17, wherein the instructions further cause the system to arrange the plurality of live video streams in the scrolling portion based on a preference of a user.

19. The system of claim 17, wherein the preselection of the first live video stream comprises navigating the first live video stream to a focus of the scrolling portion.

20. The system of claim 19, wherein the selection of the first live video stream comprises maintaining the focus on the first live video stream for a predetermined amount of time.
